(19) United States
(12) Patent Application Publication
(10) Pub. No.: US 2006/0237042 A1
(43) Pub. Date: Oct. 26, 2006

(54) Rack adjustment mechanism for an article cleaning apparatus

(75) Inventors: David Clinton Weaver, Greenwood, MS (US); John Frederick Morrison, Greenwood, MS (US); Jeffrey Alan Ryals, Sidon, MS (US); John Edward Dries, Louisville, KY (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation

(21) Appl. No.: 11/170,279

(22) Filed: Jun. 29, 2005

Related U.S. Application Data
(60) Provisional application No. 60/674,512, filed on Apr. 25, 2005.

(51) Int. Cl. B08B 3/02

(52) U.S. Cl. 134/25.2; 134/26; 134/34; 134/56 D; 134/57 D; 134/58 D; 134/135

(57) ABSTRACT

A dishwasher having an adjustable article rack is provided. The dishwasher includes a pair of horizontal slide assemblies attached to opposed sidewalls and a fixed vertically extending member is attached to each slide assembly. A vertically moveable member is attached to each fixed member, the vertically movable member of the fixed member cooperating to form a self-correcting ratchet mechanism. A rack for holding articles is attached to the vertically movable members, allowing the rack to be vertically adjusted as the movable member moves with respect to the fixed member.

### CROSS-REFERENCE TO RELATED APPLICATION

This application claims the benefit of U.S. Provisional Application 60/674,512, filed Apr. 25, 2005, incorporated by reference herein in its entirety.

### FIELD OF THE INVENTION

This invention generally relates to a dishwasher, and more specifically, to a rack assembly for a dishwasher.

### BACKGROUND OF THE INVENTION

Generally, since conventional domestic dishwashers have been designed to fit under kitchen counters, the width and depth of such dishwashers have become somewhat standardized. This standardization has created a near fixed interior volume, requiring designers to maximize the volume within a dishwasher.

One design technique used to increase the amount of space inside a dishwasher and to make such space flexible enough to hold large dishware items is to make the upper dishware rack vertically adjustable. The upper rack can then be raised to allow the lower rack to accommodate large items or can be lowered to allow the upper rack to accommodate large items.

The desirability of vertical adjustment has led to a number of designs. However, in some cases, because of the increased tolerance requirements between components supporting the upper rack, a floating or loose feeling between components of the upper rack results. This floating of the rack adjustment mechanism can contribute to a “low” or “below” quality impression of the rack and overall dishwasher.

Further, several conventional rack adjustment designs require two hands to adjust the rack, one hand to lift the rack, while the other hand operates a release mechanism. Some designs have incorporated a crank knob or wheel, which must be turned to change the vertical position of the rack. Most of these conventional rack designs are relatively large and occupy a large amount of space inside the rack or inside the dishwasher. These rack designs occupy valuable space that could otherwise be used for articles to be cleaned. Further still, identification of the level a rack is adjusted to is sometimes difficult with conventional adjustment mechanisms.

### SUMMARY OF THE INVENTION

The present invention overcomes these and other disadvantages of conventional adjustment mechanisms by providing an improved mechanism to adjust the height of the dishwasher rack. The present rack mechanism also allows the space inside the dishwasher to be customized for the size and number of articles to be cleaned.

The present adjustment mechanism is mounted to the side of an upper dishwasher rack. The adjustment mechanism is then mounted to a rack slide assembly, which typically is fixed to the wall of the dishwasher. Although the rack slide assembly used can be a commonly utilized system that allows dishwasher racks to slide in and out for loading and unloading, conventional rack slide assemblies do not allow the rack to move up and down. However, the present dishwasher rack is mounted on the adjustment mechanism, which fixes it to the rack slide and allows up and down adjustment of the dishwasher rack independent of the slide mechanism. The adjustment mechanism includes a spring-loaded pawl that is allowed to rotate, but is restrained from translation by its surrounding housing.

The adjustment mechanism includes a number of ratchet-like indentations along its length into which the pawl fits. The pawl is allowed to slide past the ratchet indentations in one direction, but is prevented from moving in the opposite direction by an indentation. The adjustment mechanism uses this pawl structure to prevent gravity from pulling the rack down past the indentation, but to allow the user to lift the rack. At the top of its travel, the pawl can reset or rotate to prevent engagement with any of the ratchet indentations. Once reset occurs, typically at the top of travel, the component holding the pawl is allowed to slide down to the lowest position, where the pawl is once again reset. Once reset at the lowest position, the pawl engages the ratchet indentations and is allowed to be raised by the user. Once again, the pawl slides past the indentations, but here engages the indentations to prevent motion once the ratchet indentation passes. In this manner of operation, the rack is adjustable up and down by the user without requiring employment of additional mechanisms. Accordingly, no external knobs or wheels are required since the adjustment mechanism is self-correcting.

### BRIEF DESCRIPTION OF THE DRAWINGS

FIG. 1 is a schematic side view of a cutaway portion of a dishwasher illustrating the present invention.

FIG. 2 is a perspective view of a dishwasher rack of the present invention showing the mounting of the adjusting mechanism to the rack slide.

FIG. 3 is an enlarged view of the side portion of the dishwasher rack.

FIGS. 4, 4A and 4B are an exploded views of the dishwasher rack adjusting mechanism.

FIG. 5 is an elevation view of one side of the T-bar portion of the adjusting mechanism.

FIG. 6 is a view of the opposite side of the T-bar portion of the adjustment mechanism.

FIGS. 7A-7F are a series of cutaway side views of the ratchet and pawl mechanism showing the height adjustment function.

FIG. 8 is an enlarged side view of the shape of the ratchet portion.

FIG. 9 is a view of the dishwasher rack of FIG. 2 from inside the dishwasher showing a height indicator mechanism.

FIG. 10 is a view of a gear and indicator wheel of the height indicator mechanism.

### DETAILED DESCRIPTION OF A PREFERRED EMBODIMENT

For a more complete understanding of the present invention, reference should be made to the following detailed description and accompanying drawings, wherein like reference numerals designate corresponding parts throughout the figures.

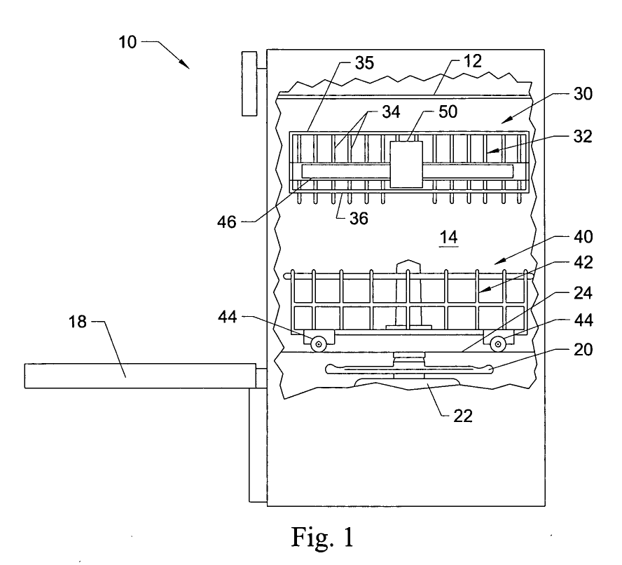

FIG. 1 illustrates a side view in schematic form of a front-loading dishwasher 10, including a tub 12 and a cleaning chamber 14. The dishwasher 10 includes a door 18 that may be opened or closed to allow loading and operating of the dishwasher. A spray arm 20 is rotatably mounted to a hub 22 in the lower portion of the cleaning chamber 14. When supplied with washing fluid from a pump (not shown), the spray arm 20 rotates about the hub 22 and sprays wash fluid upward. The upward spray of fluid cleans articles, such as dishes, held on upper rack 30 and lower rack 40. The lower rack 40 generally is basket shaped with a wire frame construction. The lower rack 40 also can include latticework front, rear, and bottom structures, and latticework side structures 42. A plurality of rollers 44 are mounted on the side structure 42 of the lower rack 40. The rollers 44 track or roll on a side wall ridge 24 formed in the tub 12.

The upper rack 30 generally is also basket shaped with a wire frame construction similar to the lower rack 40. The upper rack 30 generally also includes a latticework front, rear and bottom framework, and latticework side structures 32. Side structures 32 each include vertical wire segments 34, an upper horizontal wire section 35, and a lower horizontal wire section 36. A slide assembly 46 is attached to the wall of the tub 12. An adjustment mechanism 50 is attached to the slide assembly 46 and to the upper rack 30. The upper rack 30 is free to move in and out of the cleaning chamber 14 on the slide assembly 46. The adjustment mechanism 50 allows the upper rack 30 to be moved up and down relative to the slide assembly 46, which generally is fixed to a side wall of the dishwasher 10.

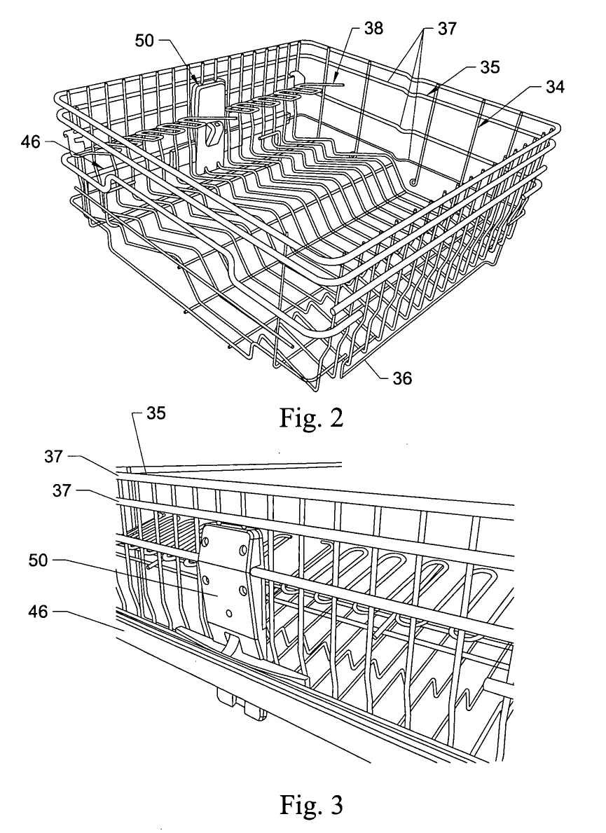

FIG. 2 shows the upper rack 30 removed from the dishwasher 10. The slide assembly 46 normally is fixed to the wall of the tub 12. Although FIG. 2 shows only one slide assembly 46 and adjustment mechanism 50, it will be appreciated that a corresponding slide assembly 46 and adjustment mechanism 50 appears on the opposite side of the rack 30 and is attached to the opposite interior wall of the tub 12. FIG. 2 shows the structure of the upper rack 30 with the upper wire segment 35 extending completely around the upper rack 30 forming an upper perimeter and the lower wire segment 36 extending similarly to form a lower perimeter. The upper wire segment 35 and lower wire segment 36 are connected by vertical wire segments 34 to form a basket-like structure. FIG. 2 also shows intermediate horizontal wire segments 37, which provide structural rigidity and strength to the upper rack 30. In FIG. 3, the adjustment mechanism 50 is shown attached to one of the intermediate wire segments 37. The upper rack 30 may also include a cup shelf 38 to hold cups, glasses, and similar items in the upper rack 30.

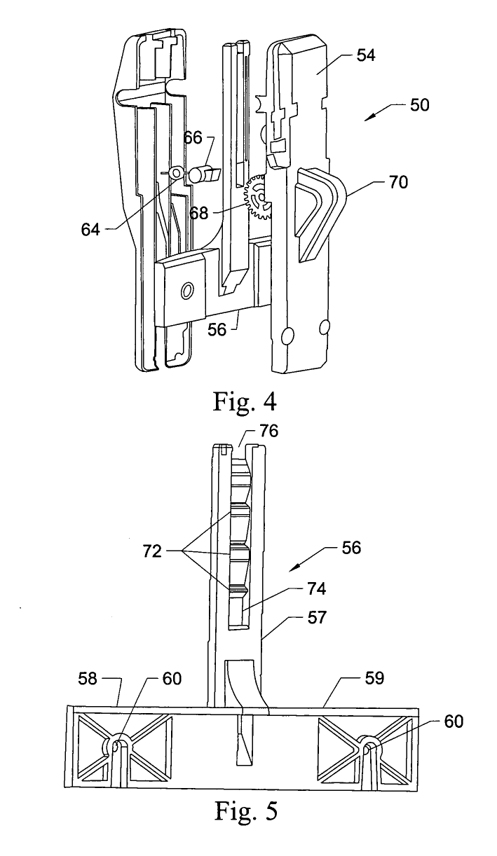

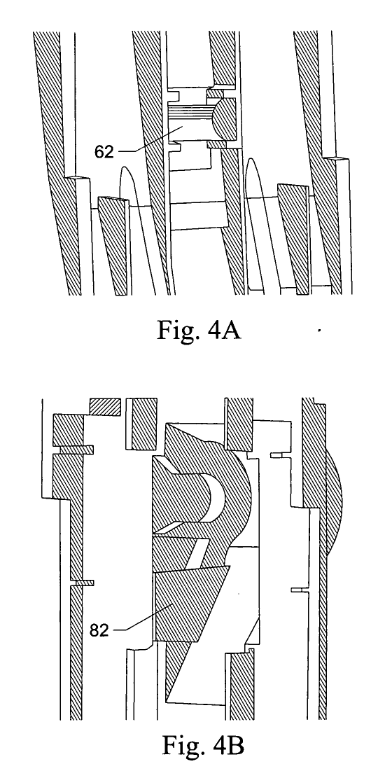

The exploded view of FIG. 4 illustrates the three primary structural components of adjustment mechanism 50; namely, the outer housing 52, inner housing 54, and T-bar 56. The outer housing 52 faces the exterior of the upper rack 30, the inner housing 54 faces the interior portion of the upper rack 30, and the T-bar 56 generally is a T-shaped structure. The horizontally extending arms 58, 59 of the T-bar 56 are attached to the slide assembly 46, generally with fasteners, such as with screws or bolts, through openings 60 formed in the horizontal arms 58, 59. The outer housing 52 includes a pocket 62 (best seen in FIG. 4A) that houses a torsion spring 64 and pawl 66 when the outer housing 52 and inner housing 54 are assembled over the T-bar 56. The inner housing 54 includes a gear and an indicator wheel 68. The gear and indicator wheel 68 are held within a projection 70 that forms part of the inner housing 54.

Vertical leg 57 of the T-bar 56 has two different sides that perform different functions in the operation of the adjustment mechanism 50. FIG. 5 shows the side of the vertical leg 57 facing the outer housing 52. A series of ratchet-like indentations 72 are formed in the vertical leg 57 of the T-bar 56 to cooperate with the pawl 66, which is carried by the outer housing 52. In addition, the vertical portion of the T-bar 56 has a lower reset opening 74 and an upper reset opening 76.

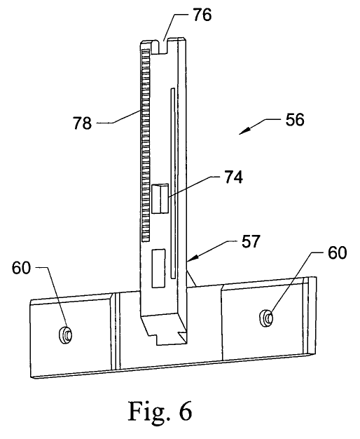

FIG. 6 shows the side of the T-bar 56 facing the inner housing 54. A rack portion 78 is formed integrally in the vertical leg 57 of T-bar 56. The rack portion 78 meshes with the indicator wheel and gear 68 when the components are assembled. A groove 80 formed in the T-bar 56 portion facing the inner housing 54 cooperates with a projection 82 (best seen I FIG. 4B) from the inner housing 54. The projection 82 fits into the groove 80 and limits the up and down movement of the inner and outer housings 54 and 52, respectively. The T-bar 56 generally remains in a fixed position, while the inner and outer housings 52 and 54 move respectively thereto to carry the upper rack 30 up and down therewith.

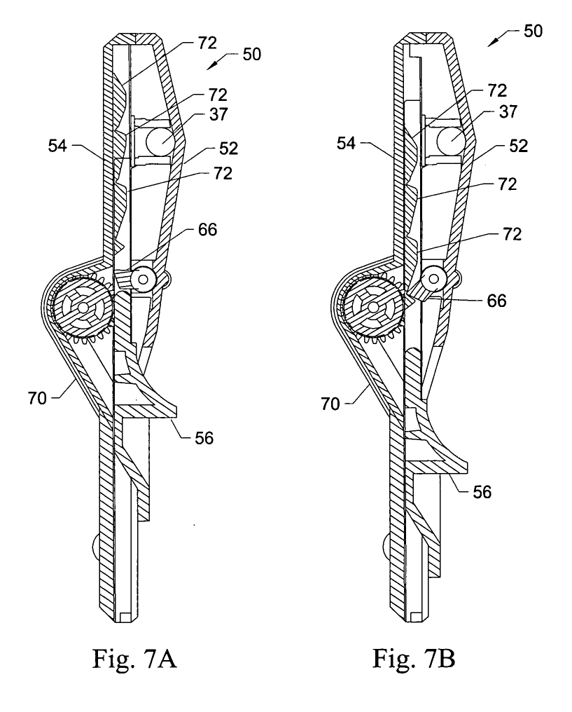

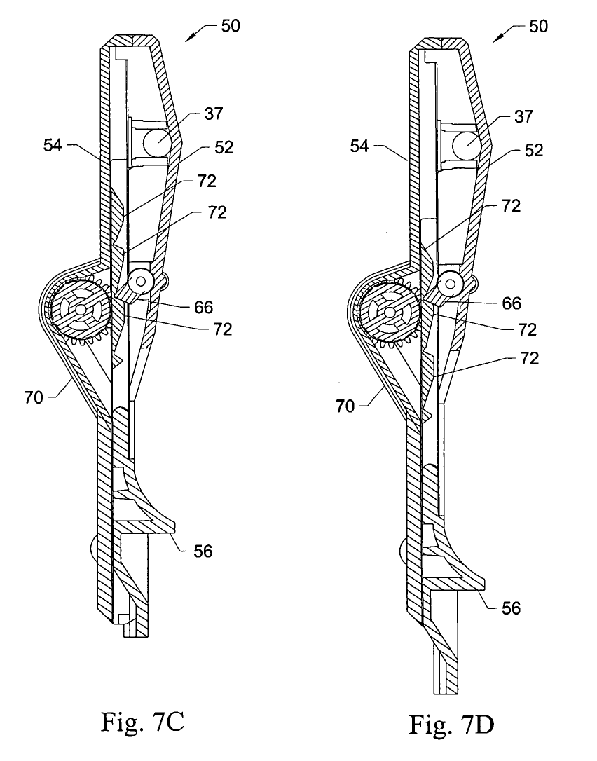

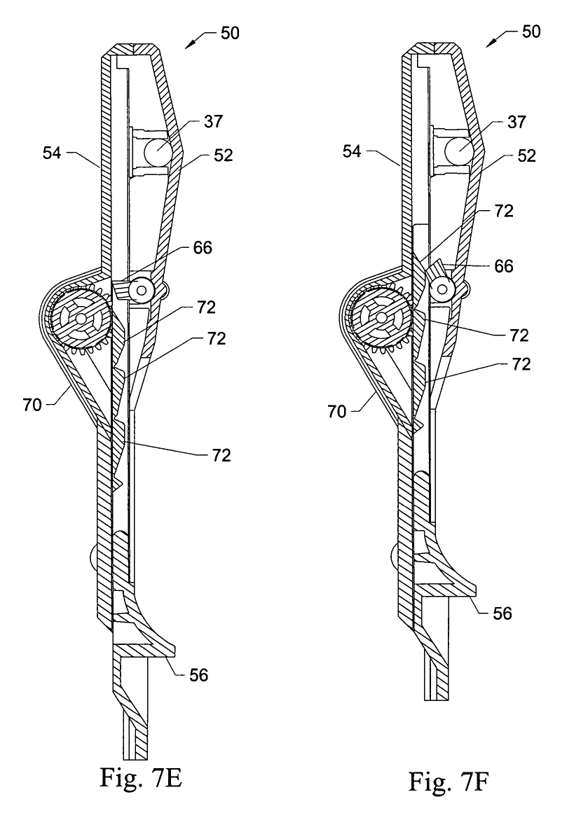

FIGS. 7A-7F show the operation of the present adjustment mechanism 50 with the inner housing 54 and outer housing 52 being assembled to the T-bar 56. The intermediate wire segment 37 passes through an opening in the outer housing 52. Thus, because the T-bar 56 is attached to the fixed slide assembly 46 and does not move, the inner and outer housings 52 and 54 move relative to the T-bar 56, causing movement of the upper rack 30 through the connection of the intermediate wire segment 37 to the outer housing 52.

FIG. 7A shows the pawl 66 located in the lower reset opening 74 formed in the T-bar 56. The pawl 66 is carried by outer housing 52 and is in the lowest position of the upper rack 30. The torsion spring 64 provides a force on the pawl 66 to hold it in the reset opening 74. The torque provided by the torsion spring 64 provides a force that attempts to return the pawl 66 to a horizontal position whenever possible. To move the upper rack 30, the user lifts the upper rack 30, causing the pawl 66 to slide out of the lower reset openings 74, generally in an upward direction, while forcing rotation in a downward orientation. When in this downward orientation, the spring loaded pawl can slide over the ratchet-like indentations 72 in the T-bar 56. However, once above a ratchet indentation 72, the pawl 66 is not allowed to slide back down over this indentation, effectively holding the rack in a vertical position. FIGS. 7B, 7C, and 7D show three locations of the pawl 66 corresponding to three levels of the upper rack 30 as lifted with respect to the ratchet-like indentations 72.

In order to return the upper rack 30 to its lowest position, the upper rack 30 is raised to the position shown in FIG. 7E, with the pawl 66 entering the upper reset opening 76 and allowing the torsion spring 64 to return the pawl 66 to a horizontal position. Once the panel is horizontal, the upper rack 30 can be lowered to its lower position since the pawl 66 can pass the ratchet-like indentations 72 on the downward path without catching on them. Once the pawl 66 reaches the lower reset opening 74, the torsion spring 64 again rotates the pawl 66 to a horizontal orientation into the position shown in FIG. 7A. Thus, the overall operation of the adjustment mechanism is analogous to a self-correcting ratchet mechanism.

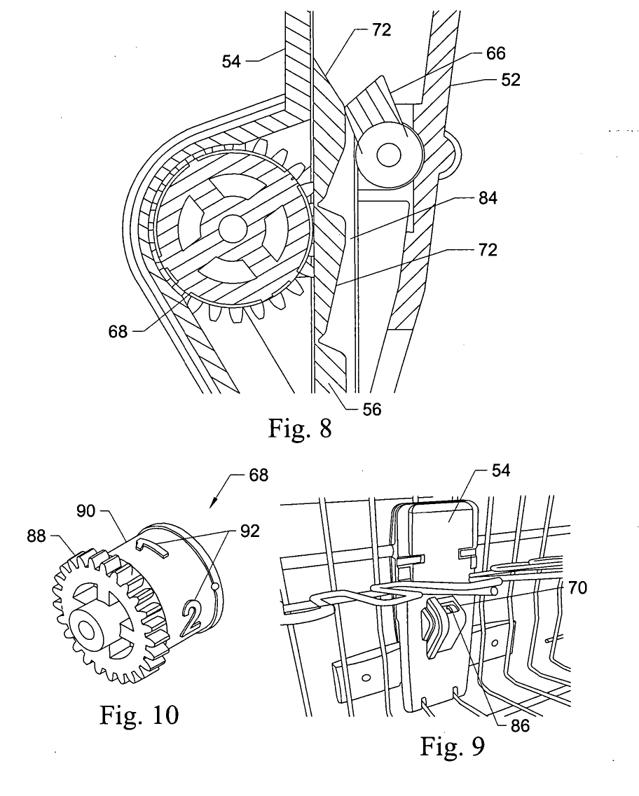

FIG. 8 shows one aspect of the design of the ratchet indentations 72. The ratchet indentations 72 are recessed slightly below the surface of the T-bar 56, which assists in lowering the upper rack 30 from the upper position to its lowest position by making the lowering smoother. Specifically, since the recess effectively lengthens the moment arm of the force, the pawl 66 is pushed outward in an upward position relative to center of rotation of pawl 66. However, the torsion spring 64 tends to resist this motion. The longer the moment arm of force, the lower force required to slide the pawl past the ratchet indentations up and down. The recess 84 can be relatively small and will generally have a shape determined as a function of the torsion spring forces and pawl shape.

FIG. 9 shows the inner housing 54 and its projection 70. The projection 70 includes a window 86 through which an indicator on the indicator wheel and gear 68 may be seen. The indicator wheel has a series of numbers thereon to display the level to which the upper rack 30 has been raised. FIG. 10 shows the indicator wheel and gear 68 removed from the projection 70. The indicator wheel and gear 68 includes two primary portions, a gear portion 88 and an indicator wheel portion 90. The two primary portions include numbers or indicia 92, typically molded therein, to show the level of the upper rack 30.

While the invention has been disclosed in its preferred form, it will be apparent to those skilled in the art that many modifications, additions, and deletions can be made without departing from the scope and spirit of the invention and its equivalent set forth in the following claims.

What is claimed is:

1. A dishwasher having an adjustable article rack comprising:
a pair of horizontal slide assemblies attached to opposed sidewalls in the dishwasher;
a vertically extending member attached to each slide assembly;
a vertically movable member attached to each extending member, said vertically movable member and said extending member cooperating to form a self correcting ratchet mechanism; and
a rack for holding articles in the dishwasher, the rack being fixed to said vertically movable members, and vertically adjustable as said vertically movable member are moved vertically.

2. The dishwasher of claim 1 wherein said rack is formed from a plurality of interconnected horizontal and vertical wire segments.

3. The dishwasher of claim 2 wherein said movable members are attached to horizontal wire segments.

4. The dishwasher of claim 3 wherein each said vertically extending member is T shaped with a base and a leg, the base being attached to said slide assembly and the leg extending upward from said slide assembly.

5. The dishwasher of claim 4 wherein said vertically movable member comprises an inner and an outer housing connected to said T shaped member.

6. The dishwasher of claim 5 wherein said T shaped member includes a plurality of vertically extending ratchet indentation members, a pawl engageable with said ratchet indentations, and a spring to provide torque to said pawl.

7. The dishwasher of claim 6 wherein the leg portion of said T shaped member further includes upper and lower reset openings formed above and below said ratchet indentations.

8. The dishwasher of claim 6 wherein said ratchet indentation member is recessed below the surface of said T-shaped member.

9. The dishwasher of claim 5 wherein said T shaped member includes a vertically extending rack portion formed in the leg portion of said T shaped member facing said inner housing and said inner housing includes a projection holding an indicator wheel and gear in mesh with said rack portion.

10. The dishwasher of claim 9 wherein said gear rotates as said rack is raised and lowered and indicia of the rack position formed in said indicator wheel are visible through an opening in said projection.

11. The dishwasher of claim 5 wherein said T shaped member includes a elongated vertical slot in the leg portion facing said inner housing and said inner housing includes a projection inserted into said vertical slot for limiting the travel of said inner housing to the length of said elongated slot.

12. The dishwasher of claim 1 wherein said slide assemblies move in and out of the dishwasher for loading and unloading of the articles.

13. A method for adjusting the position of a rack in a dishwasher comprising:
fixing a horizontal slide assembly to opposed interior walls of said dishwasher;
mounting a self-correcting ratchet mechanism to the rack;
attaching a fixed portion of said self-correcting ratchet mechanism to said horizontal slide assemblies;
vertically moving said rack relative to said horizontal slide assemblies by activating said self-correcting ratchet mechanism; and
automatically resetting said self-correcting ratchet mechanism at the top and bottom of the range of adjustment of said rack.

14. The method of claim 13 wherein said self-correcting ratchet mechanism includes a spring loaded pawl member and wherein the step of automatically resetting said self-correcting ratchet mechanism includes:
rotating said pawl into a reset opening at the top and bottom of a range of adjustment of said rack.

15. The method of claim 13 further including measuring and indicating the vertical position of said rack.

16. The method of claim 15 wherein measuring and indicating the vertical position of said rack includes:
moving a gear member as a function of vertical position of said self-correcting ratchet mechanism; and
driving a rack position indicia with said gear member.
